(19) United States
(12) Patent Application Publication
(10) Pub. No.: US 2025/0078488 A1
(43) Pub. Date: Mar. 6, 2025

(54) CHARACTER RECOGNITION USING ANALYSIS OF VECTORIZED DRAWING INSTRUCTIONS

(71) Applicant: ABBYY Development Inc., Dover, DE (US)

(72) Inventors: Sergey Kuznetsov, Moskovskaya (RU); Evgenii Kurochkin, Moscow (RU); Sergey Yablonskiy, Moskovskaya (RU); Aleksei Skotnikov, Ryazanskaya (RU)

(21) Appl. No.: 18/457,209

(22) Filed: Aug. 28, 2023

(51) Int. Cl. G06V 10/82; G06V 30/12; G06V 30/19

(52) U.S. Cl. CPC G06V 10/82; G06V 30/133; G06V 30/19007

(57) ABSTRACT

Aspects and implementations provide for techniques of fast and efficient recognition of texts in electronic documents. The disclosed techniques include, for example, accessing a description of a symbol in a page description file for a document and identifying, responsive to a character code failure, the symbol using a vectorized drawing instruction for the symbol. The character code failure includes an absence of a character code in the description of the symbol or a bad character code in the symbol description of the symbol. The techniques further include identifying a text of the document using the identified symbol.

### TECHNICAL FIELD

The implementations of the disclosure relate generally to computer systems and, more specifically, to systems and methods for extracting textual information contained in documents.

### BACKGROUND

Detection and recognition of texts and various objects contained in electronic documents is an important task in processing, storing, and referencing documents. Documents can be obtained using a variety of techniques including scanning, photographing, digital synthesis, and/or the like. Optical character recognition (OCR) identifies texts (characters, words, phrases, etc.) from rasterized (pixelated) depictions of symbols by identifying reference symbols that most closely resemble symbols depicted in the documents.

### SUMMARY OF THE DISCLOSURE

Implementations of the present disclosure are directed to fast and efficient techniques for extracting texts from electronic documents that include vectorized drawing instructions for rendering of various symbols. Vectorized drawing instructions achieve symbol rendering by specifying mathematical objects (e.g., curves) that indicate placement of lines of symbols. Because lines and symbols can be specified in multiple ways, identification of symbols directly from vectorized drawing instructions is a difficult but important operation whose accurate performance improves speed and economy of text recognition.

In one implementation, a method of the disclosure to perform text recognition includes accessing a description of a symbol in a page description file for a document, and identifying, responsive to a character code failure, the symbol using a vectorized drawing instruction (VDI) for the symbol. The character code failure includes one of an absence of a character code in the description of the symbol, or a bad character code in the symbol description of the symbol. The method further includes identifying a text of the document using the identified symbol.

In another implementation, a method of the disclosure includes obtaining a description of a first symbol in a page description file for a document. The description of the first symbol includes a VDI for the first symbol. The method further includes processing the VDI for the first symbol using a neural network model to generate one or more probabilities that the first symbol corresponds to one or more candidate symbols. The method further includes determining, using the one or more probabilities, an identity of the first symbol, and identifying a text of the document using the identity of the first symbol.

In yet another implementation, a system of the disclosure includes a memory and a processing device communicatively coupled to the memory. The processing device is to access a description of a symbol in a page description file for a document and identify, responsive to a character code failure, the symbol using a VDI for the symbol. The character code failure includes one of an absence of a character code in the description of the symbol, or a bad character code in the symbol description of the symbol. The processing device is further to identify a text of the document using the identified symbol.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 is a block diagram of an example computer system capable of supporting text recognition that deploys analysis of vectorized drawing instructions of a document, in accordance with some implementations of the present disclosure.

FIG. 2 illustrates example operations of a text recognition pipeline that uses analysis of vectorized drawing instructions of a document, in accordance with some implementations of the present disclosure.

FIG. 3 illustrates operations of font, language, or semantic matching of candidate symbols performed as part of analysis of vectorized drawing instructions of a document, in accordance with some implementations of the present disclosure.

FIG. 4 illustrates an example neural network architecture of symbol analyzer for processing of vectorized drawing instructions, in accordance with some implementations of the present disclosure.

FIG. 5 illustrates example operations of text recognition in hybrid documents, in accordance with some implementations of the present disclosure.

FIG. 6 is a flow diagram illustrating an example method of text recognition using analysis of vectorized drawing instructions of a document, in accordance with some implementations of the present disclosure.

FIG. 7 depicts an example computer system that can perform any one or more of the methods described herein, in accordance with some implementations of the present disclosure.

### DETAILED DESCRIPTION

OCR is a resource-consuming technology. Among challenges of OCR is the ability to recognize multiple sets of fonts and font variations, often for multiple languages. While most symbols can be recognized with high reliability, OCR quality is often determined by those difficult cases where a given symbol, printed or otherwise depicted (e.g., often with sub-optimal quality), can be recognized as one of a group of similar characters. OCR systems and techniques, therefore, need to be trained using many such difficult borderline symbol depictions. Such training is typically difficult, long, and expensive and often does not completely eliminate symbol misrecognition. Further elimination of remaining errors comes at increasingly greater costs with progressively lower marginal benefits.

Many electronic documents generated by word processing applications are prepared using formats (e.g., PDF, DjVu, EPUB, LCP, etc.) that include vectorized drawing instructions that specify how various symbols and/or elements of symbols are to be drawn (rather than raster instructions that directly specify pixel brightness values). Such instructions can be specified as part of font programming. In particular, font programming can include a character code for a given symbol or glyph. The character code (e.g., a hexadecimal value, such as 0x0079 Unicode code for Latin letter “y”) serves as an index into a mapping table that lists drawing instructions for the symbol/glyph. The vectorized drawing instructions can specify one or more points connected by one or more curves (e.g., Bezier curves) providing a computing or printing device with information about how each symbol is to be drawn (rendered) on a computing screen or printing media (e.g., paper). In some instances, a font identifier (e.g., “Times New Roman”) and the character code are sufficient to fully identify the symbol, e.g., when the document uses standard Unicode codes. In such instances, symbol/text recognition can be performed by directly reading the font identifier and the character code of the symbol. This provides a fast and easy way of identifying a text of the document.

In many instances, however, document creators use custom character codes (sometimes referred to as “BadEncoding”). For example, while Unicode codes for lower-case English characters “a . . . z” occupy the hexadecimal range from 0x0061 to 0x007A, a custom encoding can use any other range to encode the same characters. As a result, using custom codes directly leads to recognized characters that are different from the actual content of the document, e.g., a set of seemingly random (often foreign) letters, question marks, spaces, white or dark squares, service signs, and/or the like. In some instances, document creators may use standard character codes, but can omit the character codes to save storage space (while maintaining graphics drawing instructions) or can exercise little care in ensuring that the codes are properly included. As a result, the codes may get truncated during documents generation, storing, and/or transmission. In such instances, text recognition has to rely on the traditional OCR techniques, with all related pitfalls and ambiguities.

Aspects and implementations of the present disclosure address the above noted and other challenges of the existing technology by providing for systems and techniques capable of performing accurate and fast text recognition using analysis of vectorized drawing instructions. In some implementations, a database of drawing instructions for various characters may be maintained (and constantly updated) that does not rely on character codes. For example, once it is determined that character codes are not part of a document, e.g., of a page description (PD) file associated with the document, or that the character codes provided with the document do not result in a readable recognition of the document's text, drawing instructions for various characters of the document may be compared to drawing instructions stored the database. In some implementations, to save space, the database can store values of hashes of drawing instructions, which have a fixed size (e.g., 64-bit hashes or 128-bit hashes). Correspondingly, a hash value of a drawing instruction for a given symbol can be compared with stored hash values. A positive match indicates that the drawing instruction is known to the database and a correct symbol can then be identified, e.g., as a Unicode (or some other) value stored as part of key-value pairs in the database. A non-match indicates that the drawing instruction is unknown, e.g., that the symbol is represented via a collection of points/curves in some previously unencountered way. For example, symbol “0” can be drawn as four or more Bezier curves or as few as two Bezier curves, e.g., for the upper portion of the symbol and for the lower portion of the symbol. Some of such representations may be present in the database while other (previously unencountered) representations may be not present.

When a non-match is detected, the drawing instructions for the symbol may be processed by a symbol analyzer, which may be implemented as a trained machine learning model, e.g., a neural network classifier. The symbol analyzer may be trained to identify correct symbols based on a multitude of different drawing instructions that result in the same (or substantially similar) symbol depictions. Unlike conventional OCR systems, the system analyzer performs symbol classification based directly on textual inputs (drawing instructions) rather than on rasterized images of symbols. In some implementations, the symbol analyzer may be a recurrent network, a long short-term memory network, a network with attention, a transformer network, and/or the like. In those instances where disambiguation of similar-looking symbols, e.g., “O,” “o,” “0,” “Ω,” may be difficult, the symbol analyzer may output probabilities for different candidate symbols and an additional post-processing may be performed. Such post-processing may include font/language matchings, e.g., based on identified fonts and/or languages of other symbols (e.g., neighboring symbols) of the same document, paragraph, line, and/or the like. For example, the Greek symbol “Ω” may then be distinguished from “O,” “o,” and “0.” In those instances where font/language matching does not fully disambiguate from a number of candidate symbols, additional semantic analysis may be conducted, e.g., by looking at multiple neighboring symbols of a given symbol. For example, based on the fact that the symbol is part of a word made of letter characters, symbol “0” may be ruled out. Further, based on whether the symbol at issue is located at the beginning of a word (or sentence) or at the end of a word, a final selection from “O” and “o” may be made. In some instances, disambiguation may be performed based on a word (e.g., a sequence of symbols between spaces) being a dictionary word, an entry in a client's recording system, and/or the like.

Once document character recognition has been performed, the document can be used in a variety of ways. For example, the text of the document may be stored in a text file, e.g., using a Unicode encoding or some other recognized encoding scheme (e.g., ASCII, etc.). In another example, the text of the document may be treated as a layer of the document, which may be used when an attempt to copy a portion of the text of the document is made. For example, when a viewer of the documents marks a certain portion of the document for copying into a different application, a different document, or a different portion of the same document, a program that provides the document viewing functionality may intercept the marking and direct it to the layer of the document with the Unicode (or some other) encoding so that the marked/copied portions of the document are displayed correctly at the destination location(s) using recognizable characters. Numerous other techniques are disclosed herein. For example, the disclosed techniques may be combined with OCR algorithms to process hybrid documents, which may include raster-encoded graphics (e.g., embedded images) and vector-encoded text strings. A portion of such a hybrid document may then be processed using OCR techniques while another portion may be processed using the drawing instruction analysis.

Numerous additional implementations are disclosed herein. The advantages of the disclosed systems and techniques include but are not limited to fast and reliable character recognition that does not rely on heavily computational image processing. In particular, various characters that are difficult to recognize using OCR techniques can be quickly and without errors recognized using the drawing instruction analysis.

As used herein, a “document” may refer to any collection of symbols, such as words, letters, numbers, glyphs, punctuation marks, barcodes, pictures, logos, etc., that are printed, typed, handwritten, stamped, signed, drawn, painted, and the like, on a paper or any other physical or digital medium from which the symbols may be captured and/or stored in a digital image. A “document” may represent a financial document, a legal document, a government form, a shipping label, a purchasing order, an invoice, a credit application, a patent document, a contract, a bill of sale, a bill of lading, a receipt, an accounting document, a commercial or governmental report, or any other suitable document that may have one or more fields of interest. A “document” may include any region, portion, partition, table, table element, etc., that is typed, written, drawn, stamped, painted, copied, and the like. A “document” may be generated using any suitable computing application and may include any computer-readable file that encodes any collection of symbols represented (among other things) via drawing instructions. A “drawing instruction” may refer to any collection of commands, prompts, guidelines and/or the like that, alone or in conjunction with any application, compiler, rendered, and/or the like, inform a computing device how a specific symbol is to be represented on a computer screen, a printed media (e.g., paper), or any other media from which the symbol can be perceived by a human or by another computer. Examples of documents that may include such drawing instructions include (but are not limited to) documents in the Portable Document Format (PDF), DjVu format, electronic publication format (EPUB), Printer Command Language (PCL) format, or any other similar format.

The techniques described herein may involve training one or more neural networks to process images, e.g., to classify inputs among any number of target classes of interest. The neural network(s) may be trained using training datasets that include various electronic documents or portions thereof. During training, neural network(s) may generate a training output for each training input. The training output of the neural network(s) may be compared to a desired target output as specified by the training data set, and the error may be propagated back to various layers of the neural network(s), whose parameters (e.g., the weights and biases of the neurons) may be adjusted accordingly (e.g., using a suitable loss function) to optimize prediction accuracy. Trained neural network(s) may be applied for efficient, reliable, and economical classification of any suitable symbols, glyphs, characters, and/or combinations thereof.

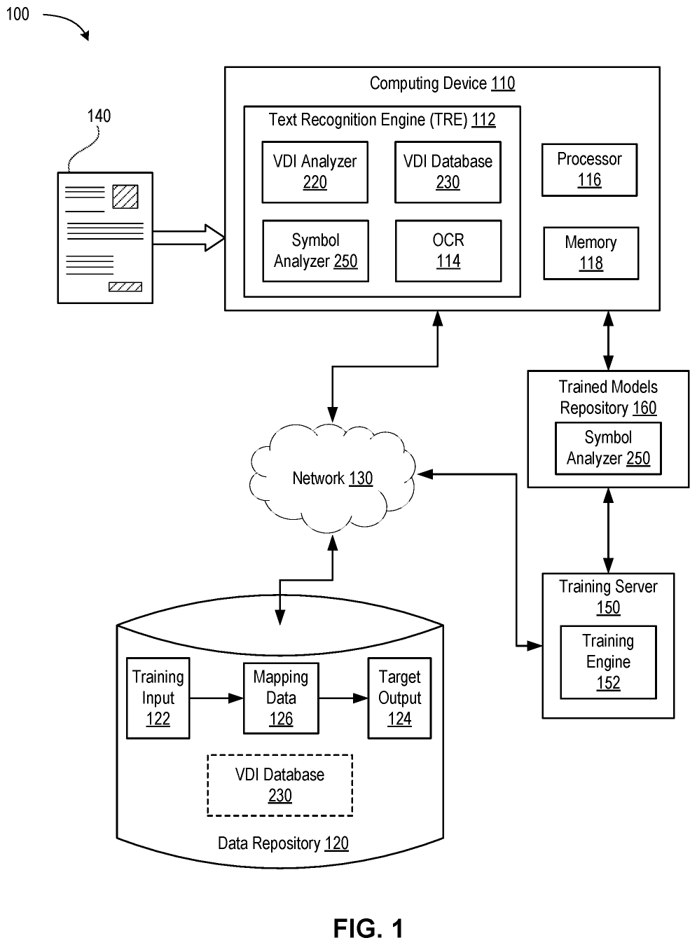

FIG. 1 is a block diagram of an example computer system 100 capable of supporting text recognition that deploys analysis of vectorized drawing instructions of a document, in accordance with some implementations of the present disclosure. As illustrated, computer system 100 may include a computing device 110, a data repository 120, and a training server 150 connected via a network 130. Network 130 may be a public network (e.g., the Internet), a private network (e.g., a local area network (LAN), wide area network (WAN)), and/or a combination thereof.

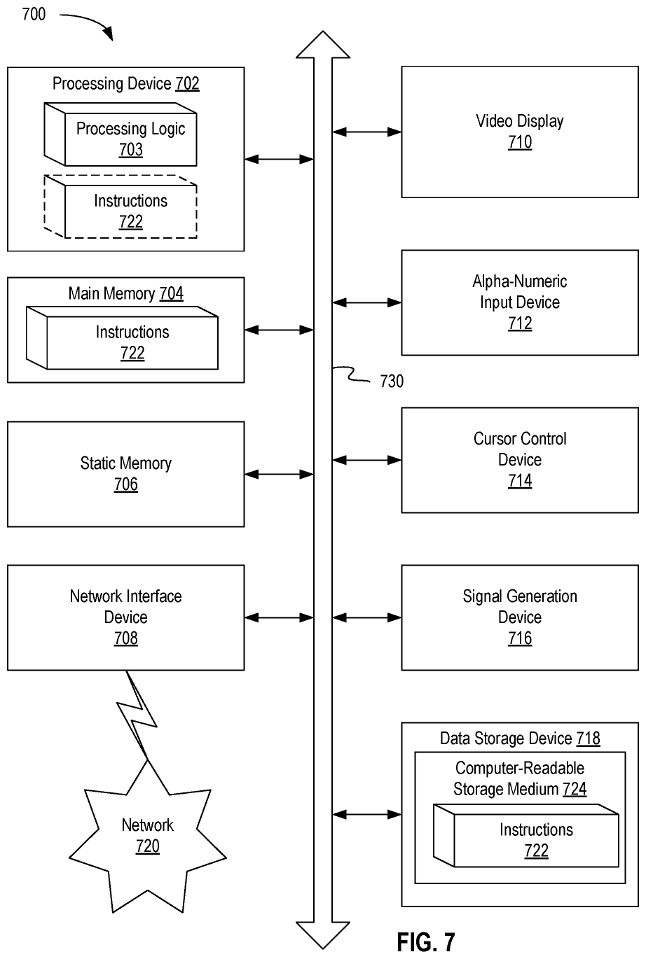

The computing device 110 may be a desktop computer, a laptop computer, a smartphone, a tablet computer, a server, a scanner, or any other suitable computing device capable of performing the techniques described herein. In some implementations, the computing device 110 may be (and/or include) one or more computer systems 700 of FIG. 7.

Computing device 110 may receive a document 140 that may include text(s), graphics, table(s), and/or the like. Document 140 may be received in any suitable manner, e.g., locally or over network 130, and may be generated using any suitable application, e.g., a word processing application, a financial application, an accounting application, an image generating application, a printing application, a social media application, an email application, and/or the like. In those instances where computing device 110 is a server, a client device connected to the server via network 130 may upload a digital copy of document 140 to the server. In the instances where computing device 110 is a client device connected to a server via the network 130, the client device may download document 140 from the server or from data repository 120.

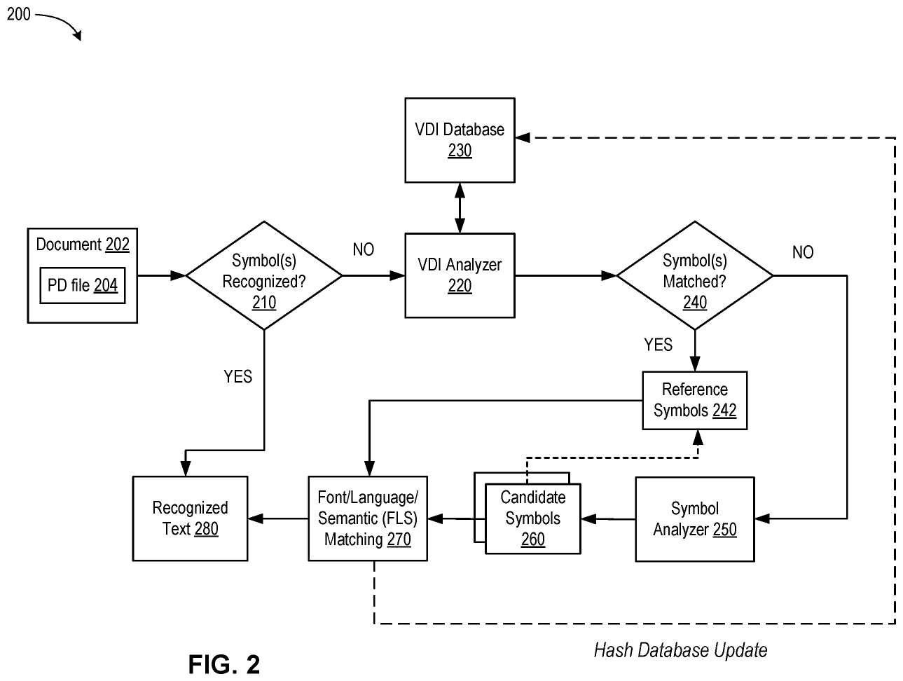

Text recognition engine (TRE) 112 may perform text recognition of document 140, as described in the instant disclosure. In some implementations, TRE 112 may perform text recognition using multiple stages. During the first stage, TRE 112 may deploy a vectorized drawing instruction (VDI) analyzer 220 to perform literal comparison of drawings instructions of document 140 and VDIs stored in a VDI database 230 to identify at least some of the symbols of document 140. During a second stage, those symbols of document 140 for which no match in the VDI database 230 has been found may be processed using a symbol analyzer 250, which may be (or include) a neural network-based classifier trained to classify symbols based on their VDIs. In some implementations, symbol analyzer 250 may output a set of probabilities that a given symbol, associated with a specific set of VDIs, corresponds to one or more known symbols, which may be symbols of any known font and/or any known language. In those instances where classifications output by VDI analyzer 220 and/or symbol analyzer 250 have not determined a symbol unambiguously, additional font/language/semantic analysis may be performed as part of a third stage that determines a most likely candidate symbol, as described in more detail below in conjunction with FIG. 2.

In some instances, determination of the most likely candidate symbol may be assisted by an OCR 114 module, which may include any known techniques of symbol recognition that are based on rasterized images of symbol, including but not limited to glyph matching, feature extraction, convolutional neural networks, and/or the like. OCR 114 may further be used in the instances of documents 140 that include portions of rasterized text that are not augmented with vectorized drawing instructions.

Various components of TRE 112 may have access to instructions stored on one or more tangible, machine-readable storage media of computing device 110 and executable by one or more processors 116 of computing device 110. Processor(s) 116 may including one or more central processing units (CPUs), graphics processing units (GPUs), data processing units (DPUs), parallel processing units (PPUs), application-specific integrated circuits (ASICs), field-programmable gate arrays (FPGA), and/or any combination thereof. Processor(s) 116 supporting operations of TRE 112 may be communicatively couple to one or more memory devices 118, including read-only memory (ROM), random access memory (RAM), flash memory, static memory, dynamic memory, and/or the like.

In some implementations, TRE 112 may be implemented as a client-based application or a combination of a client component and a server component. In some implementations, TRE 112 may be executed entirely on a client computing device, such as a desktop computer, a server computer, a tablet computer, a smart phone, a notebook computer, a camera, a video camera, or the like. Alternatively, some portion of TRE 112 may be executed on the client computing device (which may receive document 140) while other portions of TRE 112 may be executed on a server device. The server portion may then communicate results of symbol recognition to the client computing device, which may allow a user of the client computing device to perform various operations with document 140, such as text file creation, printing, document parsing, copying portions of document 140, and/or the like. Alternatively, the server portion may provide the results of symbol recognition to another application. In other implementations, TRE 112 may execute on a server device as an Internet-enabled application accessible via a browser interface. The server device may be represented by one or more computer systems, such as one or more server machines, rackmount servers, workstations, mainframe machines, personal computers (PCs), and so on.

A training server 150 may construct one or more models deployed by TRE 112, such as symbol analyzer 250 and/or models deployed as part of OCR 114 (as well as various other machine learning models, as may be applicable), and train the models to perform symbol recognition. Training server 150 may be and/or include a rackmount server, a router computer, a personal computer, a portable digital assistant, a mobile phone, a laptop computer, a tablet computer, a camera, a video camera, a netbook, a desktop computer, a media center, or any combination of the above. In some implementations, training may be performed by a training engine 152.

Training of symbol analyzer 250 may include identifying VDIs for a large number of symbols of a variety of fonts in target languages, which may include a single language or multiple languages that may be of interest to intended customers. Training of symbol analyzer 250 may include multiple sets of VDIs that are literally different (e.g., specify different points and/or connecting curves) but nonetheless result in the same rasterized images of respective symbols (e.g., with symbol “O” drawn using different sets of Bezier curves). Training of symbol analyzer 250 may further include sets of VDIs that result in similar but somewhat different (e.g., in placement of one or more pixels of respective symbols) rasterized images of the same symbols.

Symbol analyzer 250 may be trained by training engine 152 using training data that include training inputs 122 (e.g., training VDIs) and corresponding target outputs 124 (ground truth that includes correct symbols associated with the respective training VDI inputs). Training engine 152 may find patterns in the training data that map the training inputs to the target outputs (the desired result to be predicted), and train symbol analyzer 250 to capture these patterns. As disclosed in more detail below, symbol analyzer 250 may include deep neural networks, with one or more hidden layers, e.g., convolutional neural networks, recurrent neural networks (RNN), and fully connected neural networks. The training data may be stored in data repository 120 and may also include mapping data 126 that maps training inputs 122 to target outputs 124. During the training phase, training engine 152 may find patterns in the training data that can be used to map training inputs 122 to target outputs 124. The patterns can be subsequently used by symbol analyzer 250 for future predictions (inferences, classifications). In some implementations, symbol analyzer 250 may include a template-based classifier, a feature-based classifier, and/or any other suitable type of classifier.

Data repository 120 may be a persistent storage capable of storing files as well as data structures to perform text recognition in electronic documents, in accordance with implementations of the present disclosure. Data repository 120 be hosted by one or more storage devices, such as main memory, magnetic or optical storage disks, tapes, or hard drives, network-attached storage (NAS), storage area network (SAN), and so forth. Although depicted as separate from the computing device 110, data repository 120 may be part of computing device 110. In some implementations, data repository 120 may be a network-attached file server, while in other implementations data repository 120 may be some other type of persistent storage such as an object-oriented database, a relational database, and so forth, that may be hosted by a server machine or one or more different machines coupled via the network 130. In some implementations, data repository 120 may store VDI database 230.

In some implementations, training engine 152 may train symbol analyzer 250 that includes multiple neurons performing classification tasks, in accordance with various implementations of the present disclosure. Each neuron may receive its input from other neurons or from an external source and may produce an output by applying an activation function to the sum of weighted inputs and a trainable bias value. A neural network may include multiple neurons arranged in layers, including an input layer, one or more hidden layers, and an output layer. Neurons from different layers may be connected by weighted edges. The edge weights are defined at the network training stage based on a training dataset that includes a plurality of images with known fields and field values. In one illustrative example, all the edge weights may be initially assigned some random values. For every training input 122 in the training dataset, training engine 152 may compare observed output of the neural network with the target output 124 specified by the training data set. The resulting error, e.g., the difference between the output of the neural network and the target output, may be propagated back through the layers of the neural network, and the weights and biases may be adjusted in the way that makes observed outputs closer to target outputs 124. This adjustment may be repeated until the error for a particular training input 122 satisfies a predetermined condition (e.g., falls below a predetermined error). Subsequently, a different training input 122 may be selected, a new output may be generated, and a new series of adjustments may be implemented, and so on, until the neural network is trained to a sufficient degree of accuracy. In some implementations, this training method may be applied to training one or more artificial neural networks or other machine-learning models.

In some implementations, initial training of symbol analyzer 250 may be performed by a developer using a general corpus of training documents. Additional training of symbol analyzer 250 may then be performed on a client (customer) side, e.g., using a corpus of documents, fonts, languages, etc., that are specific to the client.

After symbol analyzer 250 (and or other models) has been trained, the trained model(s) may be stored in a trained models repository 160 (hosted by any suitable storage devices or a set of storage devices) and provided to computing device 110 (and/or any other computing device) for inference analysis of new documents. For example, computing device 110 may process a new document 140 using the provided symbol analyzer 250, identify symbols of new document 140, and use identified symbols in new document 140 for various tasks, including but not limited to storing, printing, copying, and so on.

FIG. 2 illustrates example operations 200 of a text recognition pipeline that uses analysis of vectorized drawing instructions of a document, in accordance with some implementations of the present disclosure. Operations 200 may include receiving a document 202 that has a text content. Document 202 may be a single-page document or a multi-page document. Document 202 may have at least a portion of text content programmed using VDIs that are different from specifying rasterized (e.g., bitmap) pixel-by-pixel intensities. VDIs of document 202 may be included in a page description (PD) file 204, which may be embedded into document 202 (e.g., integrated as part of document metadata), attached to document 202, or associated with document 202 in some other way. PD file 204 may specify how various symbols of document 202 may be drawn. In some implementations, symbols of document 202 may be specified as part of comprehensive font programming, which defines one or more fonts used in document 202 (e.g., Times New Roman, Cambria, Arial, etc.). Herein, a “font” refers to a system of symbols joined by a common style and design. Fonts may have different sizes. A font of a particular type and size (e.g., “Arial, 12pt”) may have an established enumeration (via character codes) of symbols defined as part of the font and a set of defined VDIs for the symbols. As a result, symbols defined as part of a specific font have the same character codes/VDIs across multiple documents. Additionally, PD file 204 may have any number of symbols that are not a part of any established font (e.g., custom symbols) but are defined in terms of VDIs. Such symbols may have character codes and VDIs that vary from document to document.

Text recognition pipeline for processing of document 202 may start with recognizing symbols of document 202 based on character codes of those symbols, as specified in PD file 204. If the used character codes are standard (e.g., Unicode or similar) rather than custom, character code-based symbol recognition may be successful. For example, the following sequence of Unicode character codes can be recognized as the word “delinquency”:

| | |
|---|---|
| CharCode[0x0064] | d |
| CharCode[0x0065] | e |
| CharCode[0x006C] | 1 |
| CharCode[0x0069] | i |
| CharCode[0x006E] | n |
| CharCode[0x0071] | q |
| CharCode[0x0075] | u |
| CharCode[0x0065] | e |
| CharCode[0x006E] | n |
| CharCode[0x0063] | c |
| CharCode[0x0079] | y |

If decoded symbols, like in this example, yield a set of readable characters that add up to a recognizable (e.g., dictionary) word or some other recognizable (e.g., custom) entry, the text recognition pipeline may continue (YES branch of block 210) with storing the recognized text (block 280), e.g., as part of a separate file associated with document 202 or as metadata embedded (for example, as an additional layer) into document 202.

On the other hand, decoding the same word from a custom encoding in which Latin letters are shifted (by 100) to higher Unicode values would have resulted in an readable set of question marks:

| | |
|---|---|
| CharCode[0x00C8] | [symbol] |
| CharCode[0x00C9] | [symbol] |
| CharCode[0x00D0] | [symbol] |
| CharCode[0x00CD] | [symbol] |
| CharCode[0x00D2] | [symbol] |
| CharCode[0x00D5] | [symbol] |
| CharCode[0x00D9] | [symbol] |
| CharCode[0x00C9] | [symbol] |
| CharCode[0x00D2] | [symbol] |
| CharCode[0x00C7] | [symbol] |
| CharCode[0x00DD] | [symbol] |

If the symbols decoded based on character codes, like in the last example, result in a set of unreadable characters, which do not represent a recognizable word or entry (or if character co corrupted or not included in PD file 204), the text recognition pipeline may continue (NO branch of block 210) by forwarding the symbols to VDI analyzer 220 for further symbol identification.

VDI analyzer 220 may perform a comparison of VDIs extracted from PD file 204 for individual symbols with VDIs stored in VDI database 230. VDI database 230 may store VDIs of various previously encountered (and recognized, e.g., using OCR techniques or human annotations) symbols, including symbols added by developers and symbols added by end users (e.g., clients, businesses, vendors, and the like). VDI database 230 may store VDI/symbol associations as key-value pairs, in some implementations. More specifically, various VDI entries may be stored as keys while symbols are stored as values associated with the keys. Multiple VDI entries (keys) may map on the same (symbol) value in accordance with multiple ways in which the same symbol can be represented via a set of vector graphical elements (e.g., points and curves).

In some implementations, instead of storing actual VDIs (which may be rather long, if multiple points and Bezier curve segments are used to specify how symbols are drawn), a hash function may be applied to various VDIs and outputs the of hash function may be stored as keys of DI database 230. The hash function may be any function or routine that maps variable-length inputs to fixed-length outputs. In some implementations, hashes may be 64-bit hashes, 128-bit hashes, or hashes of any suitable size. It has been determined that for a database of several thousand fonts, no hash collisions occurred even for 64-bit hashes, whose relatively modest length allows efficient and compact storage of VDI database 230.

Correspondingly, VDI analyzer 220 may compute the hash function using a drawing instruction for a given symbol as an input and use an output of the hash function as a query into VDI database 230. A positive match of the query with one of the keys of VDI database 230 means that the drawing instruction is known and a symbol for the key can be obtained from the corresponding (symbol) value of DI database 230. Symbols of document 202 for which positive matches have been found (YES branch of block 240) may be used as trusted reference symbols 242 for document 202 during construction and verification of hypotheses, in the instances of uncertain symbol identification, as disclosed in more detail below.

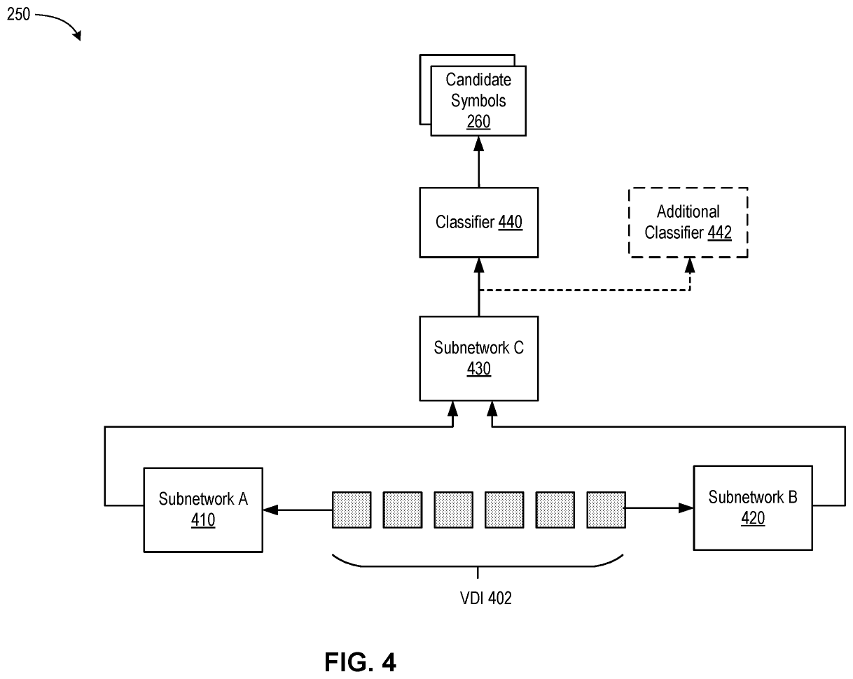

A non-match (NO branch of block 240) indicates that the drawing instruction is unknown and that the symbol is represented via a previously unencountered collection of points/curves (even though the actual difference with other VDIs represented in VDI database 230 may be small). Such non-matches may be directed for processing to a symbol analyzer 250, which may be implemented as a trained machine learning model. In some implementations, symbol analyzer 250 may be implemented using one or more neural networks, e.g., as disclosed below in conjunction with FIG. 4.

In some implementations, symbol analyzer 250 may translate VDIs into a multi-dimensional feature space where VDIs that result in similarly looking symbols have lower distance (e.g., Euclidean distance in the feature space) than dissimilarly looking symbols. For examples, symbol “O” may have a lower distance to symbols “0” and “Ω” than to symbols “K” and “M.” Accordingly, symbol analyzer 250 may process each symbol (or a set of symbols corresponding to a word or some other unit of document 202) that has not been identified by VDI analyzer using literal matching with various entries of VDI database 230, compute a feature vector, and determine, using the feature vector, one or more probability values characterizing the likelihood that the symbol corresponds to one or more candidate symbols 260. Candidate symbols 260 may be identified using any suitable indexing scheme, e.g., Unicode scheme, cp1251 scheme, mac scheme, etc.

In some instances, a particular candidate symbol 260 may be chosen as a target symbol based on high confidence of that symbol identification, e.g., provided that the candidate symbol is characterized by a probability w₁ that is significantly larger than the next largest probability w₂, such that the ratio w₁/w₂ exceeds or meets a certain threshold (e.g., 2.0, 2.5, 3.0, etc.), or satisfies some other threshold condition, e.g., a combination of a large ratio w₁/w₂ and the probability w₁ exceeding 50% or some other threshold value. In some implementations, candidate symbols 260 determined with high confidence may be added to (trusted) reference symbols 242.

In other instances of outputs of symbol analyzer 250 having low confidence, distinguishing two or more candidate symbols 260 based on computed probabilities may be difficult, e.g., if the difference of probabilities is not very significant. For example, the symbol analyzer may output probabilities w₁, w₂, etc., that are close to each other (e.g., w₁=0.45 and w₂=0.40) so that selecting one of the candidate symbols 260 over the other symbol(s) cannot be done with high confidence. In such instances, additional processing may be performed with font/language/semantic (FLS) matching 270 that uses reference symbols 242 to disambiguate a given symbol X from a plurality of candidate symbols 260.

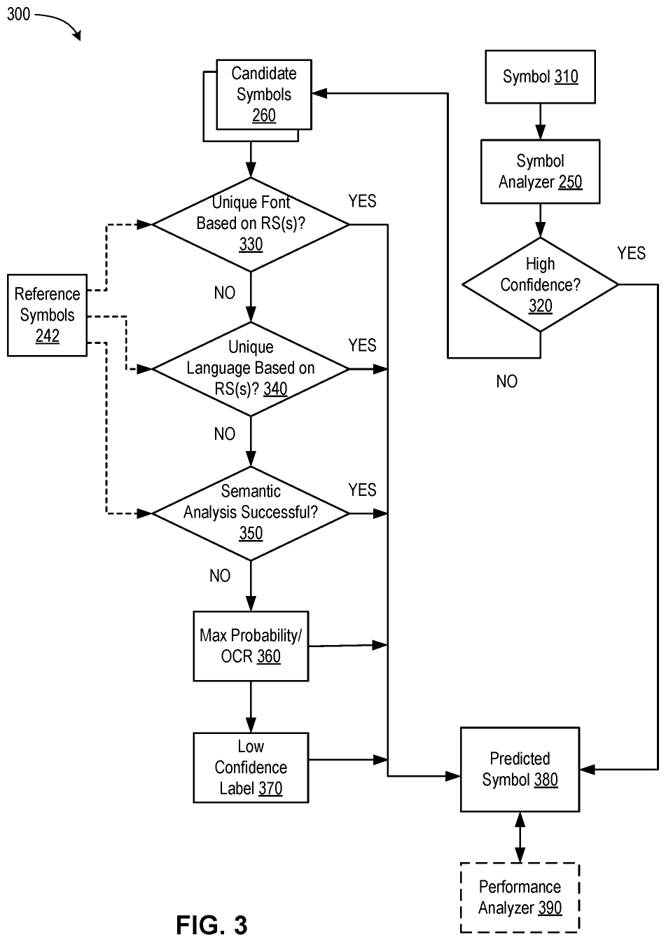

FIG. 3 illustrates operations 300 of font, language, or semantic matching of candidate symbols performed as part of analysis of vectorized drawing instructions of a document, in accordance with some implementations of the present disclosure. A symbol 310 processed by symbol analyzer 250 may have low confidence (NO branch of block 320) outputs, with multiple candidate symbols 260 identified as possible matches for symbol X. As in the above example, the maximum probability w₁ may be below an empirically set threshold, and/or the ratios of probabilities w₁/w₂, w₁/w₃ may be below another threshold, and/or some other suitable threshold condition may indicate that no single candidate symbol is sufficiently distinct from other candidate symbols 260. In such instances, a subset of physically proximate to symbol 310 (within a layout of document 202) a set of reference symbols 242 may be evaluated.

In the instances where reference symbols 242 belong to a particular font F1 (operation 330) and/or language L1 (operation 340), and one of the candidate symbols 260 belongs to the same font F1 and/or language L1 while other candidate symbols 260 belong to a different font (e.g., F2, F3, etc.) and/or language (e.g., L2, L3, etc.), the corresponding candidate symbol may be chosen as the predicted symbol 380. In some implementations, selection of one of candidate symbols 260 as predicted symbols 380 may be performed by selecting, from candidate symbols 260, a candidate symbol whose combined (e.g., average) distance in the Unicode space (or some other encoding space) to one or more reference symbols 242 has a lowest value.

In some instances, multiple candidate symbols 260 may belong to the same font (e.g., F1) and language (e.g., L1) that minimizes distance in the Unicode space to reference symbols 242. In such instances, where font/language matching does not fully differentiate from two or more candidate symbols 260, FLS matching 270 may include identifying a most likely candidate symbol based on semantics (block 350), e.g., based on a likelihood that symbol 310 and one or more reference symbols 242 may be encountered in a combination with more semantic meaning than other possible combination, e.g., as part of a dictionary word or a customary (for the client or document sender/recipient) combination of symbols. For example, predicted symbol 380 may be selected from candidate symbols “O” and “Q” in view of neighboring reference symbols “B” and “Y.” Consequently, because combination “BQY” is unlikely to be encountered as part of some English dictionary word whereas combination “BOY” is semantically a much more likely combination, FLS 270 may select candidate symbol “O” as predicted symbol 380.

If no reference symbols 242 are located sufficiently close to symbol 310 to provide font, language, or semantic context or if FLS matching 270 does not fully differentiate from a group of candidate symbol 260, a candidate symbol with the highest probability wⱼ may be selected (block 360) as predicted symbol 380. In some instances, FLS matching 270 may first eliminate unlikely candidate symbols 260 based on font, language, and/or semantic mismatch and the maximum probability selection may be performed from remaining candidate symbols 260.

In some implementations, instead of selecting the highest probability candidate symbol as predicted symbol 380, an OCR may be performed for a portion of document 202 cropped around symbol 310. In some implementations, in those instances where font, language, or semantic matching did not succeed and a final selection of predicted symbol 380 one or candidate symbols 260 as symbol X is performed based on maximum probability (and/or OCR), a low confidence label 370 may be assigned to symbol X. Warned by low confidence label 370, a developer (customer, client, etc.) may identify symbol 310 and add the identified symbol (together with the corresponding VDI) to VDI database 230. In some implementations, the identified symbol (with ground truth human annotation) may be used for additional training (retraining) of symbol analyzer 250.

In some implementations, additional training may be performed responsive to monitoring by performance analyzer 390. Performance analyzer 390 may monitor accuracy of text recognition by symbol analyzer 250 and may operate on the developer side and/or the client side.

Referring again to FIG. 2, a set of reference symbols 242 and candidate symbols 260 identified as predicted symbols may be combined into a recognized text 280 of document 202. For example, recognized text 280 that corresponds to a portion of PD file 204 that includes encoding of the word “delinquency” via unrecognizable custom character codes may be recognized using processing of DIs by DI analyzer 220 and/or symbol analyzer 250:

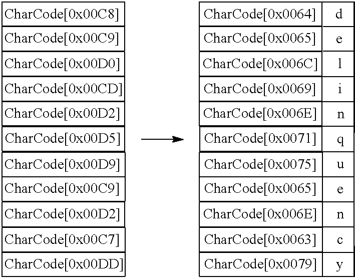 [SMILES: CCC(C)C(C)C(C)C(C)C(C)C(C)C(C)C(C)C(C)C(C)CC]

After obtaining recognized text 280, document 202 together with recognized text 280 may be used for any suitable purpose. For example, recognized text 280 may be stored in a text file, e.g., using a Unicode encoding or some other encoding (e.g., ASCII, cp1251, mac, etc.). In some implementations, recognized text 280 may be added as a new layer of document 202, which may be used when any portion of text of document 202 is copied. For example, a user working with document 202 may select a portion of the text of document 202 for copying into a different application, a different document, or within the same document, a program that provides document viewing, editing, and/or any other word processing function may direct the user selection to the layer of the document that contains recognized text 280 in Unicode (or any other encoding compatible with the application). As a result, the selected and copied portion of document 202 is displayed correctly in user-recognizable characters.

FIG. 4 illustrates an example neural network architecture of symbol analyzer 250 for processing of vectorized drawing instructions, in accordance with some implementations of the present disclosure. In some implementations, symbol analyzer may process a VDI 402 associated with an individual symbol. VDI 402 may include locations of points and curves connecting those points that, taken together, represent various symbol line boundaries used for rendering individual symbols. VDI 402 may be input into one or more subnetworks of symbol analyzer 250. In some implementations, one of the subnetworks, e.g., subnetwork A 410 may process VDI 402 in one direction, whereas another subnetwork, e.g., subnetwork B 420 may process VDI 402 in the other direction. In some implementations, subnetwork A 410 and subnetwork B 420 may have the same (or a similar) architecture. In some implementations, subnetwork A 410 and subnetwork B 420 may have a recurrent neural network (RNN) architecture, a long short-term memory (LSTM) architecture, an attention-based architecture, e.g., a transformer architecture, and/or some other neural network architecture with memory. Outputs of subnetwork A 410 and subnetwork B 420 may be combined (e.g., concatenated) and processed by a subnetwork C 430, which may include one or more fully-connected neuron layers. Subnetwork C 430 may output a set of features representative of VDI 402 in some digital feature space. The features output by subnetwork C 430 may be processed by a classifier 440 that outputs probabilities of VDI 402 corresponding to various candidate symbols 260. In some implementations, classifier 440 may be (or include) a softmax classifier or some other suitable classifier. In some implementations, symbol analyzer 250 may have an additional classifier 442 that outputs some additional information about a symbol represented by VDI 402, e.g., e.g., font attributes (e.g., monospaced, script, serif, sans serif, etc.). In some implementations, various subnetworks and classifiers shown in FIG. 4 may be trained together, e.g., using ground truth annotations for a large number of VDIs for various symbols.

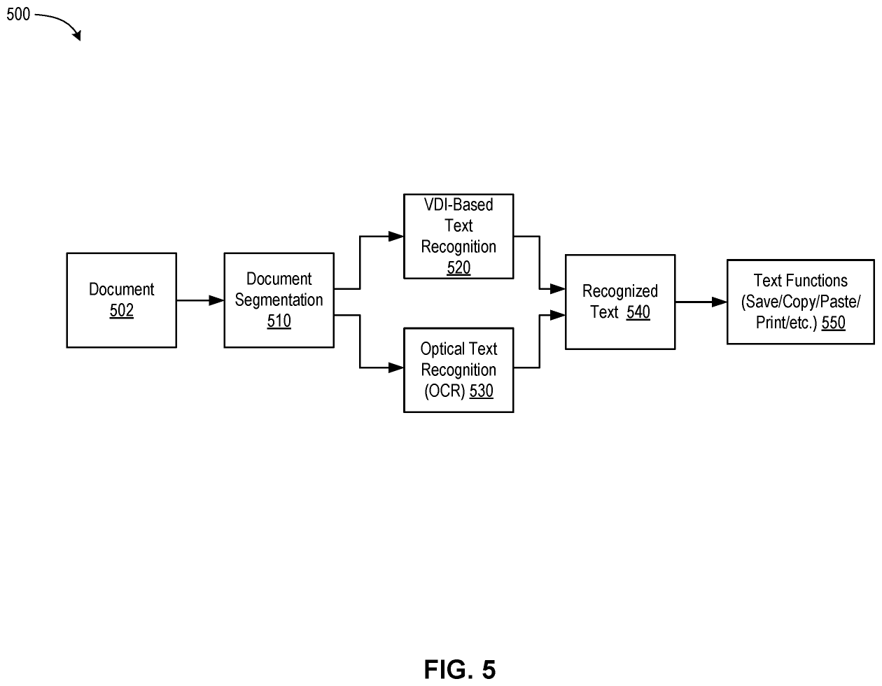

Systems and techniques disclosed above may be also used for processing of hybrid documents that combine one or more first portions of text whose rendering is specified via vectorized drawing instructions with one or more second portions of text whose rendering is specified using rasterized graphics. FIG. 5 illustrates example operations 500 of text recognition in hybrid documents, in accordance with some implementations of the present disclosure. An input document 502 having one or more first (vectorized) and one or more second (rasterized) regions of text may undergo document segmentation 510 which identifies the first regions and the second regions. The first regions may undergo VDI-based text recognition processing 520, e.g., as disclosed in conjunction with FIGS. 2-4. The second regions undergo OCR processing 530, e.g., using one or more known OCR techniques are disclosed herein. The outputs of processing 520 and 530 may include symbols specified in a common encoding (e.g., Unicode) and may be stored as part of a combined recognized text 540 for the document 502. The recognized text 540 may then be used for any suitable text functions 550, including but not limited to saving recognized text 540 or any portion of recognized text 540 as a new file, selecting, copying, pasting, etc., recognized text 540 or any portion of recognized text 540 into any existing file (including document 502 itself), and/or the like.

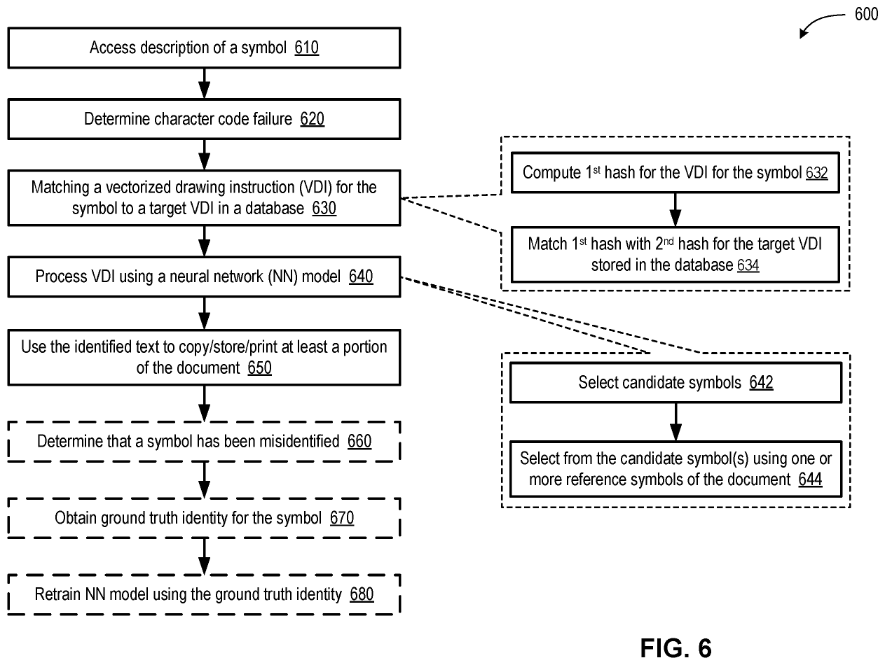

FIG. 6 is a flow diagram illustrating an example method 600 of text recognition using analysis of vectorized drawing instructions of a document, in accordance with some implementations of the present disclosure. A computing device, having one or more processing units (e.g., CPUs, GPUs, PPUs, DPUs, etc.) and memory devices communicatively coupled to the processing units, may perform method 600 and/or each of their individual functions, routines, subroutines, or operations. The processing device executing method 600 may be a processing device of computing device 110 of FIG. 1 (e.g., processor 116). In certain implementations, a single processing thread may perform method 600. Alternatively, two or more processing threads may perform method 600, each thread executing one or more individual functions, routines, subroutines, or operations of the methods. In an illustrative example, the processing threads implementing method 600 may be synchronized (e.g., using semaphores, critical sections, and/or other thread synchronization mechanisms). Alternatively, the processing threads implementing method 600 may be executed asynchronously with respect to each other. Various operations of method 600 may be performed in a different order compared with the order shown in FIG. 6. Some operations of method 600 may be performed concurrently with other operations. Some operations may be optional.

At block 610, method 600 may include accessing a description of a symbol in a page description file (e.g., PD file 204 in FIG. 2) for a document (e.g., document 202). In some implementations, the page description file may include, for an individual symbol (e.g., letter, numeral, service symbol, mathematical symbol, etc.), a vectorized drawing instruction (VDI) and, in some instances, a character code. At block 620, method 600 may detect a character code failure, which may include an absence of the character code in the description of the symbol or a bad character code in the symbol description of the symbol. The bad character code occurrence may be determined by detecting that a symbol decoded using the bad character code is out of place, based on some criteria, e.g., that the decoded symbol is not a letter (numeral) where a letter (numeral) is expected, that the decoded symbol does not match a known or expected language of the document, that a combination of several symbols does not constitute a dictionary word in any language, or based on some other global or local criteria.

Responsive to the detected character code failure, method 600 may continue with identifying the symbol using the VDI, e.g., as illustrated with blocks 630 and 640 in FIG. 6. For example, method 600 may include identifying the symbol using the VDI for the symbol, e.g., by matching, at block 630, the VDI for the symbol to a representation of a target VDI stored in a database. As illustrated in the top callout portion of FIG. 6, matching the VDI for the symbol to the representation of the target VDI may include, at block 632, computing a first hash value for the VDI for the symbol and matching, at block 634, the first hash value with a second hash value for the target VDI stored in the database.

In some implementations, e.g., when no match with a stored VDI in the database (or a stored hash of a VDI) is found, method 600 may continue, at block 640, with processing the VDI for the symbol using a neural network model. The neural network model may generate probabilities that the symbol corresponds to one or more candidate symbols. In some implementations, the neural network model may include (e.g., as illustrated in FIG. 4) a first subnetwork (e.g., subnetwork A 410) processing the VDI for the symbol in a first direction, a second subnetwork (e.g., subnetwork B 420) processing the VDI for the symbol in a second direction, and a third subnetwork (e.g., subnetwork C 430 and/or classifier 440) processing combined outputs of the first subnetwork and the second subnetwork. In some implementations, at least one of the first subnetwork or the second subnetwork may include a recurrent network, a long short-term memory network, a network with self-attention, or a transformer network.

In some implementations, block 640 may include operations, illustrated in the bottom callout portion of FIG. 6, e.g., operations that use the generated probabilities to identify the symbol. More specifically, at block 642, method 600 may include selecting, based on the generated probabilities, a plurality of the candidate symbols. At block 644, method 600 may continue with selecting the symbol from the plurality of the candidate symbols. In some implementations, selecting the symbol may include using a degree of font similarity of the plurality of the candidate symbols and one or more reference symbols of the document. In some implementations, selecting the symbol may include using a degree of language similarity of the plurality of the candidate symbols and the one or more reference symbols of the document. In some implementations, selecting the symbol may include using a degree of semantic similarity of the plurality of the candidate symbols and the one or more reference symbols of the document.

In some implementations, the one or more reference symbols of the document may be identified using one or more VDIs stored in a database (e.g., successful matches for queries into the database). In some implementations, the one or more reference symbols may be identified, with at least a threshold confidence, by the neural network model.

In some implementations, the neural network model used at block 640 may be trained using (i) a training input that includes a VDI for a training symbol (or multiple VDIs for a plurality of training symbols), and (i) a target output that includes an identity of the training symbol(s).

The symbol identified using one or more operations of blocks 630-640 may be used in identifying a text of the document. After the text of the document has been identified, method 600 may support using the identified text, at block 650, for a variety of operations. By way of example and not limitation, such operations may include copying a first portion of the document to a new location within the document or to a new document. Such operations may also include storing, using the identified text of the document, a second portion of the document. Such operations may also include printing, using the identified text of the document, a third portion of the document. (The terms “first,” “second,” and “third” should be understood as mere identifiers that do not presuppose any temporal and/or semantic order.)

In some implementations, the neural network model may be retrained as part of method 600. More specifically, at block 660, it may be determining that the symbol has been misidentified. At block 670, method 600 may include obtaining a ground truth identity for the symbol (e.g., using a human annotation or an OCR-generated annotation). At block 680, method 600 may continue with retraining the neural network model using the ground truth identity for the symbol.

FIG. 7 depicts an example computer system 700 that can perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 700 includes a processing device 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 718, which communicate with each other via a bus 730.

Processing device 702 (which can include processing logic 703) represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 722 for implementing various modules and components of TRE 112 of FIG. 1 and to perform the operations discussed herein (e.g., method 600 illustrated in FIG. 6).

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker). In one illustrative example, the video display unit 710, the alphanumeric input device 712, and the cursor control device 714 may be combined into a single component or device (e.g., an LCD touch screen).

The data storage device 718 may include a computer-readable storage medium 724 on which is stored the instructions 722 embodying any one or more of the methodologies or functions described herein. The instructions 722 may also reside, completely or at least partially, within the main memory 704 and/or within the processing device 702 during execution thereof by the computer system 700, the main memory 704 and the processing device 702 also constituting computer-readable media. In some implementations, the instructions 722 may further be transmitted or received over a network 720 via the network interface device 708.

While the computer-readable storage medium 724 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method to perform text recognition, the method comprising:
accessing a description of a symbol in a page description file for a document;
identifying, responsive to a character code failure, the symbol using a vectorized drawing instruction (VDI) for the symbol, wherein the character code failure comprises one of:
an absence of a character code in the description of the symbol, or
a bad character code in the symbol description of the symbol; and
identifying a text of the document using the identified symbol.

2. The method of claim 1, wherein identifying the symbol using the VDI for the symbol comprises:
matching the VDI for the symbol to a representation of a target VDI stored in a database; and
identifying the symbol based on the target VDI.

3. The method of claim 2, wherein matching the VDI for the symbol to the representation of the target VDI comprises:
computing a first hash value for the VDI for the symbol; and
matching the first hash value with a second hash value for the target VDI stored in the database.

4. The method of claim 1, wherein identifying the symbol using the VDI for the symbol comprises:
processing the VDI for the symbol using a neural network model to generate probabilities that the symbol corresponds to one or more candidate symbols; and
using the generated probabilities to identify the symbol.

5. The method of claim 4, wherein the neural network comprises:
a first subnetwork processing the VDI for the symbol in a first direction,
a second subnetwork processing the VDI for the symbol in a second direction, and
a third subnetwork processing combined outputs of the first subnetwork and the second subnetwork.

6. The method of claim 5, wherein at least one of the first subnetwork or the second subnetwork comprises one of:
a recurrent network,
a long short-term memory network,
a network with self-attention, or
a transformer network.

7. The method of claim 4, wherein using the generated probabilities to identify the symbol comprises:
selecting, based on the generated probabilities, a plurality of the candidate symbols; and
selecting the symbol from the plurality of the candidate symbols, using at least one of:
a degree of font similarity of the plurality of the candidate symbols and one or more reference symbols of the document,
a degree of language similarity of the plurality of the candidate symbols and the one or more reference symbols of the document, or
a degree of semantic similarity of the plurality of the candidate symbols and the one or more reference symbols of the document.

8. The method of claim 7, wherein the one or more reference symbols of the document are identified by one or more of:
identifying the one or more reference symbols using one or more VDIs stored in a database; or
identifying, with at least a threshold confidence, the one or more reference symbols using the neural network model.

9. The method of claim 4, wherein the neural network model is trained using (i) a training input comprising a VDI for a training symbol, and (i) a target output comprising identity of the training symbol.

10. The method of claim 4, further comprising:
determining that the symbol has been misidentified; and
obtaining a ground truth identity for the symbol; and
re-training the neural network model using the ground truth identity for the symbol.

11. The method of claim 1, further comprising at least one of:
copying, using the identified text of the document, a first portion of the document to a new location within the document or to a new document;
storing, using the identified text of the document, a second portion of the document; or
printing, using the identified text of the document, a third portion of the document.

12. A method comprising:
obtaining a description of a first symbol in a page description file for a document, wherein the description of the first symbol comprises a vectorized drawing instruction (VDI) for the first symbol;
processing the VDI for the first symbol using a neural network model to generate one or more probabilities that the first symbol corresponds to one or more candidate symbols; and
determining, using the one or more probabilities, an identity of the first symbol; and
identifying a text of the document using the identity of the first symbol.

13. The method of claim 12, further comprising:
obtaining a VDI for a second symbol;
matching the VDI for the second symbol to a representation of a target VDI stored in a database;
identifying the second symbol based on the target VDI; and
using the identified second symbol in identifying the text of the document.

14. The method of claim 13, wherein matching the VDI for the second symbol to the representation of the target VDI comprises:
computing a first hash value for the VDI for the second symbol; and
matching the first hash value with a second hash value for the target VDI stored in the database.

15. The method of claim 13, wherein at least one of processing the VDI for the first symbol using the neural network or matching the VDI for the second symbol to the representation of a target VDI stored in the database is responsive to a character code failure, wherein the character code failure comprises one of:
an absence of character coding in a page description file of the document, or
a bad character coding in the page description file of the document.

16. The method of claim 12, wherein the neural network comprises:
a first subnetwork processing the VDI for the first symbol in a first direction, and
a second subnetwork processing the VDI for the first symbol in a second direction, and
a third subnetwork processing combined outputs of the first subnetwork and the second subnetwork.

17. The method of claim 12, wherein using the one or more probabilities comprises:
selecting, based on the one or more probabilities, a plurality of the candidate symbols; and
identifying the first symbol from the plurality of the candidate symbols, using at least one of:
a degree of font similarity of the plurality of the candidate symbols and one or more reference symbols of the document,
a degree of language similarity of the plurality of the candidate symbols and the one or more reference symbols of the document, or
a degree of semantic similarity of the plurality of the candidate symbols and the one or more reference symbols of the document.

18. The method of claim 12, further comprising at least one of:
copying a first portion of the document to a new location within the document or to a new document;
storing a second portion of the document; or
printing a third portion of the document.

19. A system comprising:
a memory; and
a processing device communicatively coupled to the memory, the processing device to:
access a description of a symbol in a page description file for a document;
identify, responsive to a character code failure, the symbol using a vectorized drawing instruction (VDI) for the symbol, wherein the character code failure comprises one of:
an absence of a character code in the description of the symbol, or
a bad character code in the symbol description of the symbol; and
identify a text of the document using the identified symbol.

20. The system of claim 19, wherein to identify the symbol using the VDI for the symbol, the processing device is to perform at least one of:
match the VDI for the symbol to a representation of a target VDI stored in a database; or
process the VDI for the symbol using a neural network model to generate probabilities that the symbol corresponds to one or more candidate symbols.
